(19) United States
(12) Patent Application Publication
(10) Pub. No.: US 2026/0113625 A1
(43) Pub. Date: Apr. 23, 2026

(54) ACCESSBILITY MANAGEMENT OF A USER EQUIPMENT TO A DEVICE TECHNOLOGY

(71) Applicant: T-MOBILE INNOVATIONS LLC, Overland Park, KS (US)

(72) Inventor: Ariful Islam KAZI, Renton, WA (US)

(21) Appl. No.: 18/924,503

(22) Filed: Oct. 23, 2024

(51) Int. Cl. H04W 8/24; H04W 48/08

(52) U.S. Cl. CPC H04W 8/24; H04W 48/08

(57) ABSTRACT

Embodiments of the present disclosure are directed to systems and methods for managing device technology accessibility of a user equipment (UE) in a communications network. For example, a user equipment's (UE) compatibility for one or more device technologies may be determined by analyzing device certification information of the UE, device profile information of the UE, and one or more network capabilities of the communications network. The one or more device technologies associated with the UE may be modified based on the analysis in order to appropriately manage the device technology accessibility of the UE.

### SUMMARY

The present disclosure is directed, in part, to managing device technology accessibility of a user equipment (UE) in a communications network, substantially as shown and/or described in connection with at least one of the figures, and as set forth more completely in the claims.

According to various aspects of the technology, a communications network may consist of a UE and a Device Management System (DMS), which may store device profile information of the UE. The DMS may identify the UE based on its Type Allocation Code (TAC), which may come from a Global System for Mobile Communications Association (GSMA) database. This TAC data may be accessible to network operators so they can access and verify the device's capabilities and help ensure compliance with global standards.

In a scenario where a network operator retrieves device certification information from the GSMA (e.g., updates to the TAC database), the operator may use this information to verify newly certified devices or updated device models. This device certification information, which may include details about device capabilities (e.g., supported technologies like LTE, 5G, Visual Voice Mail (VVM), etc.), may be incorporated into the operator's DMS. The DMS may cross-reference this new data with device profile information to help ensure that the UE is correctly identified and provisioned with services in the appropriate way.

For example, by analyzing the device certification information and device profile information along with network capabilities of the communications, the DMS may determine which device technologies need to be added or modified for the UE. One aspect of the determination may involve determining whether the technology is best handled in-network (e.g., provisioning the service using the infrastructure of the communications network) or offloaded to a third-party provider (e.g., Apple's servers handling VVM processing). As more third-party providers can independently process requests on their own servers, network operators can outsource certain tasks to these providers, optimizing the use of network resources. By efficiently offloading tasks like VVM processing to third-party servers, the operator reduces the strain on its own network infrastructure, which may help enable better scalability and enhanced network performance.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed; and

FIG. 4 illustrates a flow chart of an exemplary method for managing device technology accessibility of a UE in a communications network in which implementations of the present disclosure may be employed.

### DETAILED DESCRIPTION

By way of background, when a device technology is provisioned to a UE in a communications network, the process may begin with identifying the device and determining its capabilities based on its device profile. This profile may be stored in the DMS, which may include information about the device such as the TAC, manufacturer, model, supported frequency bands, and technologies. The DMS may interact with various components of the communications network to help ensure that the UE is provisioned with the appropriate services based on its capabilities and the network's configuration.

When the UE first connects to the network, its International Mobile Equipment Identity (IMEI), which contains the TAC, may be used to retrieve the device profile information from the DMS. This profile may be helpful to determine which device technologies are supported by the UE. For example, if the UE supports Voice over LTE (VoLTE), the network may provision the service to the UE. A Device Provisioning System (DPS) may work with the DMS to dynamically provision network resources and configure the UE for available services using the device profile information from the DMS.

Network operators may face challenges when determining the specific frequency bands and device technologies (e.g., features and functionalities) that can be provisioned to the UE. One of the issues is that the TAC updates provided by the GSMA do not include all of the granular information about a device's capabilities, such as the specific frequency bands supported by the device or the complete list of features. In this way, the TA database primarily includes high-level details like the device's manufacturer, model, and general radio access technology, and may leave out details that network operators may need to use to provision services accurately and efficiently.

To address this gap, network operators may rely on a combination of data sources that may be integrated to create a detailed device profile of the UE. Besides the TAC database, operators may gather detailed information from device manufacturers, which may include specifications for supported frequency bands, features, and software configurations. In addition to external sources, internal teams within the operator's organization may provide further insights based on field testing or device certification processes that evaluate how specific devices interact with the network. These sources of information may be integrated and included in the UE's device profile information to form a comprehensive view of the UE's capabilities and to help allow the operator to make more informed decisions about provisioning services and network access to the UE.

Once the operator has collected and integrated the relevant data, the UE's capabilities may be compared with the network capabilities (e.g., functionalities and services the communications network can provide based on network-specific parameters like available frequency bands, supported technologies, and QoS settings). The DMS (or a controller integral or separate from the DMS) may initiate a logic flow in response to an indication that triggers this analysis. For example, this indication could come from a notification that the GSMA TAC database has been updated with new device certification information, or it could be initiated during a periodic sweep of the device profiles stored in the DMS to help ensure they remain up to date. During this flow, the DMS may determine whether new or modified device technologies should be added to the device profile. For example, if the network discovers that the UE now supports a new 5G band, the network (e.g., DMS) may modify the device profile to add this capability and ensure that the UE can connect to the new 5G frequency when available. Similarly, if the UE supports Carrier Aggregation (CA) across new LTE bands, the device profile may be updated to reflect this capability, helping enable the network to optimize data throughput and service quality for that UE.

In some aspects, the process may involve modifying existing device technologies based on network capabilities and resource allocation strategies. For example, the device profile information associated with the UE may indicate that a feature like VVM is provisioned using in-network capabilities, meaning the network's own servers handle the processing of voicemails. However, if it is later determined that a third-party provider (e.g., Apple's VVM service) can handle this service more efficiently, the device profile information can be updated. This update may involve modifying a value associated with the existing VVM technology from provisioning it in-network to provisioning it through the third-party provider. Such changes may help the network optimize resource allocation by offloading processing tasks to external services where appropriate, thus improving network efficiency and reducing strain on in-network resources.

In one non-limiting example scenario, a network operator receives an update from the GSMA indicating that a new TAC has been assigned to a recently released smartphone model. The DMS processes this notification and retrieves the basic information about the device from the TAC database. However, the information provided by the GSMA only includes the manufacturer, model, and general capabilities like 5G support. The network operator still lacks specific details about which 5G frequency bands and device technologies are supported by the new device. To fill this gap, the operator reaches out to the device manufacturer and gathers detailed documentation about the device's supported frequency bands (e.g., support for 5G NR Band n78, Carrier Aggregation, etc.). This information is then incorporated into the device's profile in the DMS. The system then compare the device's profile with the network's existing capabilities. The DMS updates the device profile to enable access this new 5G band, helping ensure that the UE can take full advantage of the operator's 5G services. Additionally or alternatively, the system could identify the device's profile currently specifies that VVM is being provisioned via the network's internal servers. After reviewing performance metrics (e.g., one or more network capabilities), the operator decides to offload VVM processing to a third-party provider (e.g., Apple's VVM service, which supports the UE natively). As a result, the DMS modifies the value associated with VVM provisioning in the device profile from an in-network value to a third-party value. This shift reduces the load on the network's voicemail infrastructure and improves efficiency by outsourcing the processing.

Accordingly, a first aspect of the present disclosure is directed to a system for managing device technology accessibility of a user equipment (UE) in a communications network The system includes a network device comprising one or more processors. The system further includes a non-transitory computer-readable media configured to receive, at the network device, an indication to initiate a logic flow. The computer-readable media is further configured to retrieve, by the network device during the logic flow, device certification information associated with the UE and device profile information associated with the UE. The computer-readable media is further configured to, based on the device certification information, the device profile information, and one or more network capabilities of the communications network, modify one or more device technologies associated with the UE.

A second aspect of the present disclosure is directed to a non-transitory computer-readable media that, when executed, cause a user equipment comprising one or more processors to perform operations for managing device technology accessibility of a user equipment (UE) in a communications network. For example, the computer-readable media is configured to receive, at the network device, an indication to initiate a logic flow. The computer-readable media is further configured to retrieve, by the network device during the logic flow, device certification information associated with the UE and device profile information associated with the UE. The computer-readable media is further configured to, based on the device certification information, the device profile information, and one or more network capabilities of the communications network, modify one or more device technologies associated with the UE.

A third aspect of the present disclosure is directed to a method for managing device technology accessibility of a user equipment (UE) in a communications network. The method includes receiving an indication to initiate a logic flow. The method further includes retrieving, by the network device during the logic flow, device certification information associated with the UE and device profile information associated with the UE. The method further includes, based on the device certification information, the device profile information, and one or more network capabilities of the communications network, modify one or more device technologies associated with the UE.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, a “Device Management System (DMS)” may refer to a centralized system used by network operators to manage, configure, monitor, and/or maintain mobile devices throughout their lifecycle on a communications network. The DMS may store and process a variety of information related to each UE. For example, the DMS may store information such as a device profile of a UE, which may contain details like the device's TAC, manufacturer, model, and hardware capabilities. The DMS may also maintain information about each UE's capabilities as they relate to device technologies that may be provisioned to the UE. The DMS may work closely with a Device Provisioning System (DPS) to ensure that devices are provisioned with the correct services. For example, when a UE attempts to register on the communications network, the DPS may reference the device profile information in the DMS to determine which network resources and services should be activated for that UE.

As used herein, a “Global System for Mobile Communications Association (GSMA)” may refer to an international organization that represents mobile network operators and device manufacturers, overseeing the standardization and regulation of mobile communications. One role of the GSMA is to manage a TAC database, which may contain information about mobile devices, including their TAC codes, manufacturer, model, and basic capabilities. The TAC database may be regularly updated by the GSMA as new devices are registered and assigned TAC codes by manufacturers. Updates to the TAC database may occur when new devices are certified or when existing models undergo changes (e.g., new variants or firmware upgrades). This information may be made available to network operators through a downloadable database or API access, which may allow operators to query and retrieve the latest TAC data.

As used herein, “device certification information” associated with a UE may refer to data provided by the GSMA (e.g., from the GSMA's TAC database) that verifies the UE's compliance with global communications standards. Such device certification information may include a TAC, which uniquely identifies each device model and is used as part of the device's IMEI. The device certification process may help ensure that new devices are compliant with regulatory and technical standards before they are allowed to operate on mobile networks worldwide. Device certification information may include details such as the UE's manufacturer, model, some supported radio access technologies, and/or some basic hardware features.

As used herein, “device profile information” may refer to data stored in the DMS that may be used to manage and provision devices within a communications network. This profile information may include device-specific data such as a TAC and a breakdown of the specific frequency bands a UE may support (e.g., LTE Band 3, 5G Band n78). The profile information may include a list of the device technologies associated with the UE, which may include configuration settings, firmware versions, and/or any network-specific parameters that the UE may need to operate on the network.

As used herein, one or more “device technologies” associated with a UE may refer to specific features and functionalities supported by the UE, which may be maintained within the device profile information stored in the DMS. These technologies may include capabilities such as VoLTE, VoWiFi, 5G NR, Carrier Aggregation (CA), and VVM. A device technology may have an associated value that indicates how it should be provisioned or managed, which can vary depending on whether the service is handled by a third-party provider or by the in-network services offered by the operator. For example, the values associated with the one or more device technologies may indicate that VoLTE should be provisioned by the operator's in-network VoLTE infrastructure, whereas VVM might be provisioned via a third-party application.

As used herein, one or more “network capabilities” of a communications network may refer to various functionalities and services that a communications network may provide to a UE based on network-specific parameters and device compatibility. These capabilities may include the ability to support different radio access technologies such as GSM, UMTS, LTE, and 5G, as well as advanced services like VoLTE, VoWiFi, and 5G NR. Network capabilities may also encompass frequency band support, which may define the specific radio frequencies a device can use to connect to the network. Additionally, network capabilities may include QoS, which helps ensure prioritized bandwidth for critical services, and support for Carrier Aggregation, which may allow the UE to combine multiple frequency bands for faster data speeds.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

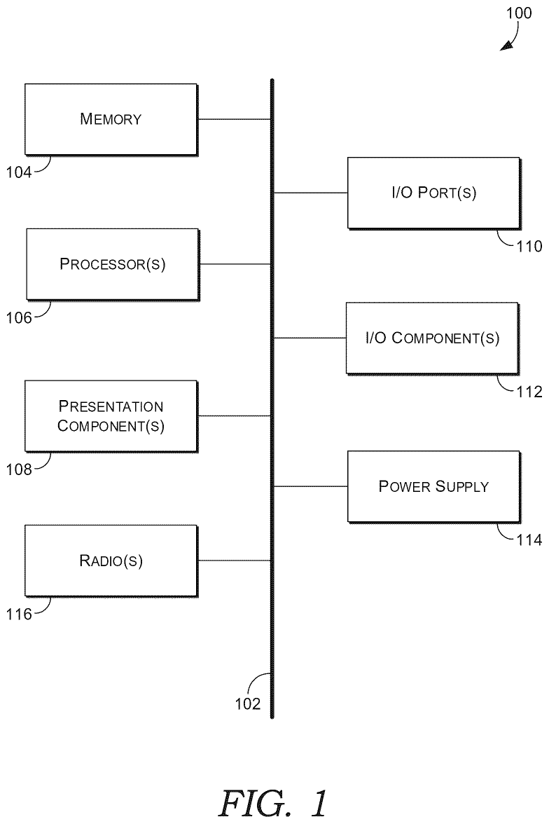

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

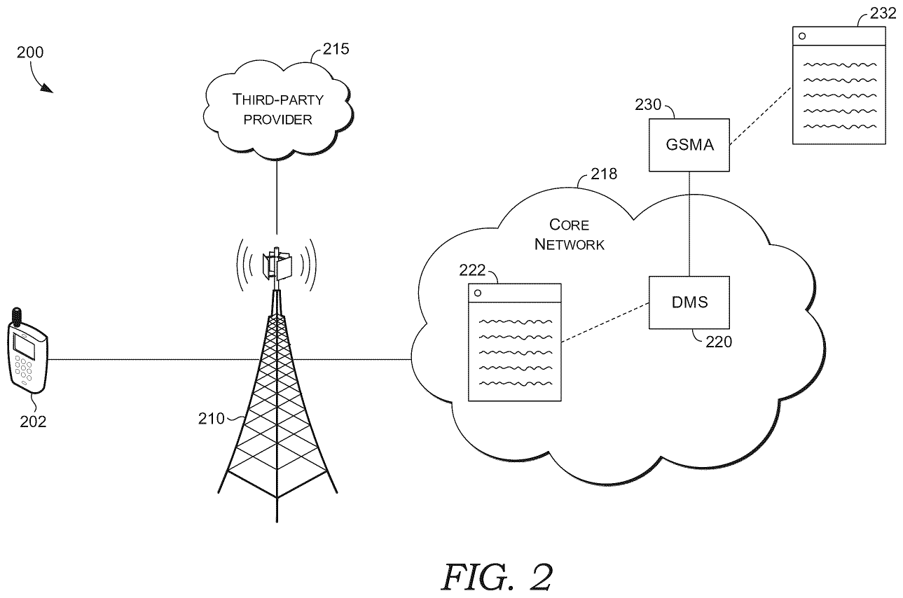

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a third-party provider 215, a core network 218, a DMS 220 that maintains device profile information 222 associated with the UE 202, and a GSMA 230 that stores device certification information 232 associated with the UE 202, though in some implementations, it may not be necessary for certain features to be present. The network environment may include a number of routers, switches, and the like. The network environment 200 is generally configured for wirelessly connecting the UE 202 to data or services that may be accessible through the core network 218 or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The first base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The third-party provider 215, in some aspects, may assist in servicing the UE 202 by handling specific tasks that would otherwise be managed by the core network 218. For example, in the case of a service like VVM, instead of the network managing voicemail storage and retrieval, the third-party provider 215 (e.g., an application developer) may take over this functionality. When a voicemail is left for the user, the third-party provider 215 may store the message on its own servers, and the UE 202 may retrieve it through the third-party provider's 215 dedicated application. This may allow the user to interact with the service through a familiar application interface while reducing the need for the network to allocate internal resources for voicemail management.

The core network 218 may provide services and connectivity to the UE 202. For example, the core network 218 may play a role in service provisioning for the UE 202 by managing functions that enable access to network services and helping ensure the UE 202 is correctly configured to use them. When the UE 202 connects to the network, the core network 218, through elements such as the AMF, may authenticate the UE 202 and check its device profile to determine what services the UE 202 is entitled to. Through its control over authentication, resource allocation, and session management, the core network 218 helps ensure that the UE 202 is provisioned with the correct services based on its profile and network capabilities.

The DMS 220, or a controller integrated to or separate from the DMS 220, may receive an indication to initiate a logic flow related to device provisioning or service updates. This indication may come from various sources within the network or external systems that monitor and/or manage the device profile information 222. For example, the indication may comprise a notification from the GSMA database, signaling that new device certification information 232 (e.g., updated TACs or new device models) has been added. This may trigger the DMS 220 to determine whether the updated information impacts the device profiles stored within the system and requires adjustments to provisioning. Another type of indication may come from periodic network sweeps or audits, where the DMS 220 regularly reviews existing device profile information 222 to help ensure they remain aligned with network capabilities and configurations. During these sweeps, if inconsistencies or outdated profiles are detected, the DMS 220 could initiate the logic flow to update device technologies or modify service provisioning accordingly. Additionally, the DMS 220 could receive indications from internal network monitoring systems or network operations teams. For example, if new network capabilities (e.g., the activation of new frequency bands or services) are deployed, the DMS 220 may receive an indication to assess whether existing device technologies associated with the UE 202 need to be updated to support these new capabilities. Similarly, server performance metrics could indicate that a device technology (e.g., VVM) is better handled by the third-party provider 215 rather than the network itself, prompting the DMS 220 to adjust the provisioning method.

In response to the received indication, the DMS 220 (or the associated controller) may initiate the logic flow by retrieving the device certification information 232 and the device profile information 222 associated with the UE 202. The DMS 220 may query the GSMA 230 or a local repository that contains the most up-to-date device certification information (e.g., device certification information 232), such as the TAC, device manufacturer, model, and basic capabilities. The DMS 220 may retrieve the device profile information 222 stored within its internal systems. The device profile information 222 may contain network-specific data associated with the UE 202 such as the supported frequency bands, network access technologies, and other technical attributes that may reflect how the device has been previously provisioned in the network. The device profile information 222 may also include any customized settings, service entitlements, and/or configurations applied to the device to enable services. By retrieving both the device certification information 232 from the GSMA 230 and the device profile information 222, the DMS 220 may gain a comprehensive view of the UE's 202 capabilities and its current network configuration.

After retrieving the device certification information 232, the device profile information 222, and assessing the network capabilities of the communications network, the DMS 220 (or the associated controller) may proceed to modify one or more device technologies associated with the UE 202 based on this analysis. For example, the DMS 220 may evaluate whether the current device profile information 222 aligns with the latest device certification information 232 and the network's available resources. If the GSMA 230 certification update reveals that the UE 202 now supports a newly deployed 5G frequency band, the DMS 220 may modify the device profile information 222 to enable the UE 202 to access this band, helping ensure the UE 202 can take advantage of enhanced network speeds and performance.

Similarly, the DMS 220 may identify outdated or suboptimal configurations for existing device technologies. For example, if the analysis shows that a service like VVM, which was previously provisioned using in-network capabilities, could now be handled more efficiently by a third-party provider (e.g., the third-party provider 215), the DMS 220 may modify the associated device technology in the device profile information 222. This may involve changing the provisioning method from using the network's own infrastructure (e.g., the core network 218) to relying on the third-party provider 215. The DMS may also modify the QoS setting and/or Carrier Aggregation parameters based on the network's updated capabilities. For example, if the network supports new CA combinations or advanced 5G NR features, the device profile information 222 may be updated to reflect these enhancements, helping ensure the UE 202 can utilize the latest optimizations for faster and more reliable data transmission. In some aspects, the modification may involve removing or disabling device technologies that are no longer compatible with the core network 218 or that have been superseded by more advanced alternatives.

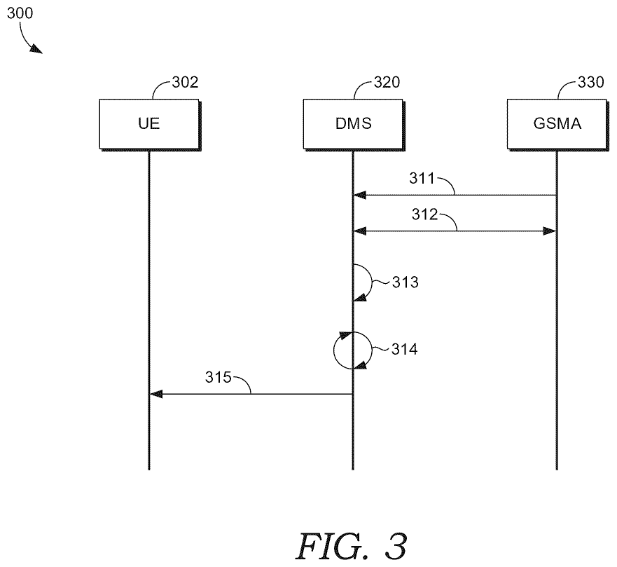

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a UE 302, a DMS 320, and a GSMA 330. In some aspects, the UE 302 may be the same or similar to the UE 202, the DMS 320 may be the same or similar to the DMS 220, and the GSMA 330 may be the same or similar to the GSMA 230 discussed above.

FIG. 3 illustrates an example method for managing device technology accessibility of a user equipment (UE) in a communications network. At a first step 311, the DMS 320 (or the controller) may receive an indication to initiate a logic flow aimed at determining whether, and how, to modify one or more device technologies of the UE 302. The indication may come from several sources within the network or from external systems, and the indication may serve as the trigger for the DMS 320 to initiate the logic flow. The indication may comprise any one or more of a notification from the GSMA 330 database signaling that new or updated device certification information has been made available, a periodic sweep, or an indication from internal network systems when significant updates to the network's infrastructure occur (e.g., deployment of new 5G bands) as discussed previously.

At a second step 312, after receiving the indication to initiate the logic flow, the DMS 320 may retrieve the device certification information associated with the UE 302 from the GSMA 330 database. The DMS 320 may query the GSMA's 330 global TAC database, which may contain detailed information about certified devices. The query may be based on the TAC, an 8-digit code embedded in the device's IMEI that uniquely identifies the make and model of the UE 302. The DMS 320 may send a request to the GSMA's 330 database through a secure API or other standardized communication protocols. Upon receiving the request, the GSMA 330 returns the device certification information.

At a third step 313, the DMS 320 may retrieve the device profile information of the UE 302 from its internal databases or repositories. The device profile information may contain detailed, network-specific data about the UE's 302 capabilities and how it has been provisioned in the network. The DMS 320 may retrieve this information by querying its internal system using the UE's 302 IMEI or TAC, which may uniquely identify the UE 302 in the communications network. The device profile information may contain any one or more of supported frequency bands, radio access technologies, provisioned services, QoS settings, SIM configurations, and firmware version of the UE 302.

At a fourth step 314, after analyzing both the device certification information from the GSMA 330 and the device profile information stored in the DMS 320, the DMS 320 may determine that one or more device technologies associated with the UE 302 need to be modified. These modification may comprise adding, updating, or reconfiguring device technologies to align with the UE's 302 certified capabilities and the network's current infrastructure and services. Once the need for modification is identified, the DMS 320 may update the device profile information to reflect the changes. This process may involve altering specific configuration parameters in the profile based on the updated information. For example, if the DMS 320 identified that the UE 302 now supports a newly available 5G NR band (e.g., Band n78) based on the latest certification information, the DMS 320 may update the profile to enable access to this band. In another example, if the DMS 320 detects that a service, such as VVM, can be more efficiently managed by a third-party provider (e.g., third-party provider 215) rather than in-network. In such an example, the DMS 320 may modify the provisioning method in the device profile, which may involve changing the VVM provisioning from using the network's internal voicemail servers to relying on third-party service, thus updating the associated values and routing configurations. In another example, the DMS 320 may modify the QoS parameters, for example, if the UE 302 gains support for Carrier Aggregation across new LTE or 5G frequency bands. In this case, the DMS 320 may update the device profile to reflect the new Carrier Aggregation configuration, helping ensure that the UE 302 can combine multiple frequency bands for enhanced throughput and performance. In some aspects, the DMS 320 may modify the device profile by updating its internal database and helping ensure that the new configuration aligns with the network's capabilities and the device's certified features.

At a fifth step 315, after the DMS 320 modified the device technologies associated with the UE 302, the updated configuration may be used to provision the relevant services to the UE 302. This step may involve pushing the newly modified profile to the UE 302 and helping ensure that the network elements responsible for managing services and sessions are aware of the changes. For example, once the DMS 320 updates the device profile information with new or modified technologies, the DMS 320 may communicate with core network (e.g., core network 218) components to begin the provisioning of services. This may be accomplished using Over-the-Air (OTA) provisioning. OTA may allow the DMS 320 to deliver the updated configuration directly to the UE 302. In parallel, the DMS 320 may coordinate other network elements to provision the UE's 302 services such as the AMF and PCF. After these updates are made, the core network components may synchronize with the UE 302 to help ensure that the one or more modified device technologies are active and functioning as intended. As a result, the UE 302 may benefit from optimized service delivery, improved network performance, and access to the latest network features, such as faster data speeds through new frequency bands, better service prioritization through QoS enhancements, or more efficient handling of services through third-party providers.

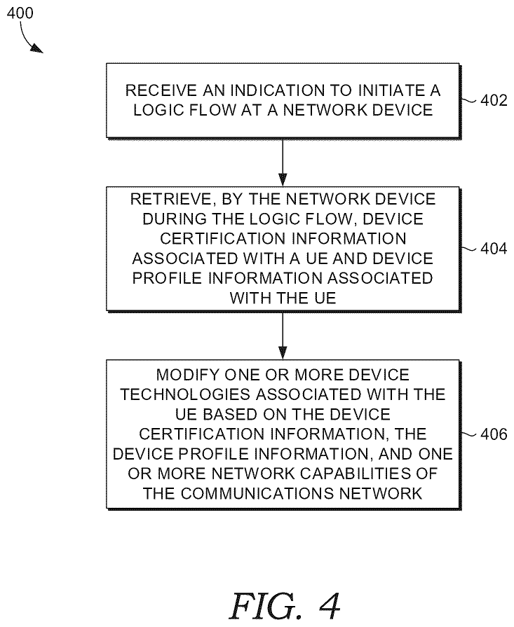

Turning now to FIG. 4, a flow chart is provided that illustrates one or more aspects of the present disclosure relating to a method 400 for managing device technology accessibility of a user equipment (UE) in a communications network. For example, at a first step 402, an indication is received to initiate a logic flow at a network device. At a second step 404, device certification information and device profile information associated with the UE are retrieved by the network device during the logic flow. At a third step 406, one or more roaming device technologies associated with the UE are modified based on the device certification information, the device profile information, and one or more network capabilities of the communications network.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for managing device technology accessibility of a user equipment (UE) in a communications network, the system comprising:
a network device comprising one or more processors; and
a non-transitory computer-readable media comprising executable instructions that, when executed, causes the network device to perform operations in a communication network, comprising:
receiving, at the network device, an indication to initiate a logic flow;
retrieving, by the network device during the logic flow, device certification information associated with the UE and device profile information associated with the UE; and
based on the device certification information, the device profile information, and one or more network capabilities of the communications network, modifying one or more device technologies associated with the UE.

2. The system of claim 1, wherein the network device comprises a Device Management System (DMS).

3. The system of claim 2, wherein the device profile information is retrieved from the DMS.

4. The system of claim 1, wherein the device profile information comprises frequency bands that the UE supports.

5. The system of claim 1, wherein the device certification information is retrieved from a Global System for Mobile Communications Association (GSMA) database.

6. The system of claim 5, wherein the indication comprises a notification that the GSMA database has been updated with new device certification information.

7. The system of claim 1, wherein the device certification information comprises a Type Allocation Code (TAC) of the UE.

8. The system of claim 1, wherein the one or more device technologies comprises features and functionalities supported by the UE.

9. The system of claim 1, wherein the one or more network capabilities comprises functionalities and services that the communications network provides to the UE based on network-specific parameters of the communications network.

10. The system of claim 1, wherein modifying the one or more device technologies comprises adding a new technology device to the device profile information.

11. The system of claim 1, wherein modifying the one or more device technologies comprises modifying a first value associated with an existing device technology associated with the UE to a second value.

12. The system of claim 11, wherein the first value comprises provisioning the existing device technology to the UE using in-network capabilities of the communications network, and wherein the second value comprises provisioning the existing device technology to the UE using a third-party provider or third-party application.

13. A non-transitory computer-readable media comprising executable instructions that, when executed, causes a user equipment comprising one or more processors to perform operations for managing device technology accessibility of a user equipment (UE) in a communications network, the executable instructions comprising the steps of:
receiving, at the network device, an indication to initiate a logic flow;
retrieving, by the network device during the logic flow, device certification information associated with the UE and device profile information associated with the UE; and
based on the device certification information, the device profile information, and one or more network capabilities of the communications network, modifying one or more device technologies associated with the UE.

14. The computer-readable media of claim 13, wherein modifying the one or more device technologies comprises adding a new technology device to the device profile information.

15. The computer-readable media of claim 13, wherein modifying the one or more device technologies comprises modifying a first value associated with an existing device technology associated with the UE to a second value.

16. The computer-readable media of claim 15, wherein the first value comprises provisioning the existing device technology to the UE using in-network capabilities of the communications network, and wherein the second value comprises provisioning the existing device technology to the UE using a third-party provider or third-party application.

17. A method for managing device technology accessibility of a user equipment (UE) in a communications network, the method comprising:
receiving, at the network device, an indication to initiate a logic flow;
retrieving, by the network device during the logic flow, device certification information associated with the UE and device profile information associated with the UE; and
based on the device certification information, the device profile information, and one or more network capabilities of the communications network, modifying one or more device technologies associated with the UE.

18. The method of claim 17, wherein modifying the one or more device technologies comprises adding a new technology device to the device profile information.

19. The method of claim 17, wherein modifying the one or more device technologies comprises modifying a first value associated with an existing device technology associated with the UE to a second value.

20. The method of claim 19, wherein the first value comprises provisioning the existing device technology to the UE using in-network capabilities of the communications network, and wherein the second value comprises provisioning the existing device technology to the UE using a third-party provider or third-party application.
